(19) United States
(12) Patent Application Publication
(10) Pub. No.: US 2010/0023157 A1
(43) Pub. Date: Jan. 28, 2010

(54) METHODS AND SYSTEMS FOR FABRICATING A COMPONENT

(76) Inventors: Steven Michael Burgess, Lynnfield, MA (US); Gregory M. Burgess, Maineville, OH (US); Larisa Alexandra Elman, Swampscott, MA (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 12/181,082

(22) Filed: Jul. 28, 2008

(51) Int. Cl. G06F 19/00

(52) U.S. Cl. 700/186

(57) ABSTRACT

A method for fabricating a component using a tool is provided. The method includes determining a model tool contact path for the component based on a component geometry, nominal tool tip path, tool geometry, the component geometry including a grid system having a plurality of elements and nodes at an intersection of the elements. The method also includes measuring a geometric property of the component relative to the model component geometry, generating a tool contact path and tool tip path corresponding to the measured geometric property, and at least partially fabricating the component using the generated tool contact path.

### BACKGROUND OF THE INVENTION

The field of the invention relates generally to fabricating components, and more specifically to fabricating components using machining processes.

Manufacturing processes for use in fabricating at least some known components, for example gas turbine engine components, use an integrated system of Computer Aided Design (CAD) and Computer Aided Manufacturing (CAM). A CAD solid model is first developed using the part geometry of the component, and then a toolpath using integrated CAM software is developed on the same operating platform. With an integrated CAD/CAM system, the toolpath and component geometry are associative, i.e. any changes made to the part geometry can be easily and automatically applied to the toolpath via execution of a regenerate function. When associative CAD/CAM is used in conjunction with on-machine probing systems, part inspection data can be used to automatically update part geometry and toolpath without human intervention, commonly referred to as “adaptive machining”.

However, some known systems use non-integrated, non-associative CAD/CAM system. Such systems are typically used when the integrated CAM package is incapable of creating a toolpath for highly complex part geometry (e.g. turbomachinery). The programmer must then rely on a separate, specialized CAM package operating on a different operating platform. This loss of associativity precludes employment of adaptive machining methods and the realization of associated economic benefits.

### BRIEF DESCRIPTION OF THE INVENTION

In one aspect, a method for fabricating a component using a tool is provided. The method includes determining a model tool contact path for the component based on a component geometry, the component geometry including a grid system having a plurality of elements and nodes at an intersection of the elements. The method also includes measuring a geometric property of the component relative to the model component geometry, generating a tool contact path corresponding to the measured geometric property, and at least partially fabricating the component using the generated tool contact path.

In another aspect, a system for fabricating a component using a fabricating tool is provided. The system includes at least one machining tool configured to machine at least a portion of the component, and a processor operatively coupled to the machining tool and configured to execute a process that facilitates fabricating the component. The processor, when executing the process, is programmed to determine a model tool contact path for the component based on a component geometry, the component geometry including a grid system having a plurality of elements and nodes at an intersection of the elements. The processor is also programmed to measure a geometric property of the component relative to the model component geometry, and generate a tool contact path corresponding to the measured geometric property.

In yet another embodiment, a method for fabricating a component is provided. The method includes mapping an expected surface of the component using a grid system having a plurality of elements and nodes at an intersection of the elements, generating a plurality of tool contact paths based on said mapped expected surface, and determining a plurality of tool tip paths using the determined model tool contact points that are offset from the tool contact path, the offset related to the geometry of the tool. The method also includes measuring an actual portion of the surface of the component relative to the mapped expected surface, transforming the grid system in response to the measured actual surface, and interpolating a correlated displacement of the tool contact path and, subsequently the actual tool tip path using the transformed grid system.

### BRIEF DESCRIPTION OF THE DRAWINGS

FIG. 1 is a perspective view of an exemplary component within a gas turbine engine.

FIG. 2 is a partially broken away perspective view of a portion of the component shown in FIG. 1.

FIG. 3 is a schematic view of an exemplary embodiment of a system for fabricating a component.

FIG. 4 is a flow chart illustrating an exemplary method for use in fabricating the component shown in FIG. 1.

FIG. 5 is a perspective view of the component shown in FIG. 1 with a generated grid.

FIG. 6 is a schematic illustration of a portion of the grid shown in FIG. 5.

FIG. 7 is a schematic illustration of the component during fabrication.

FIG. 8 is schematic illustration of a portion of a transformed grid shown.

### DETAILED DESCRIPTION OF THE INVENTION

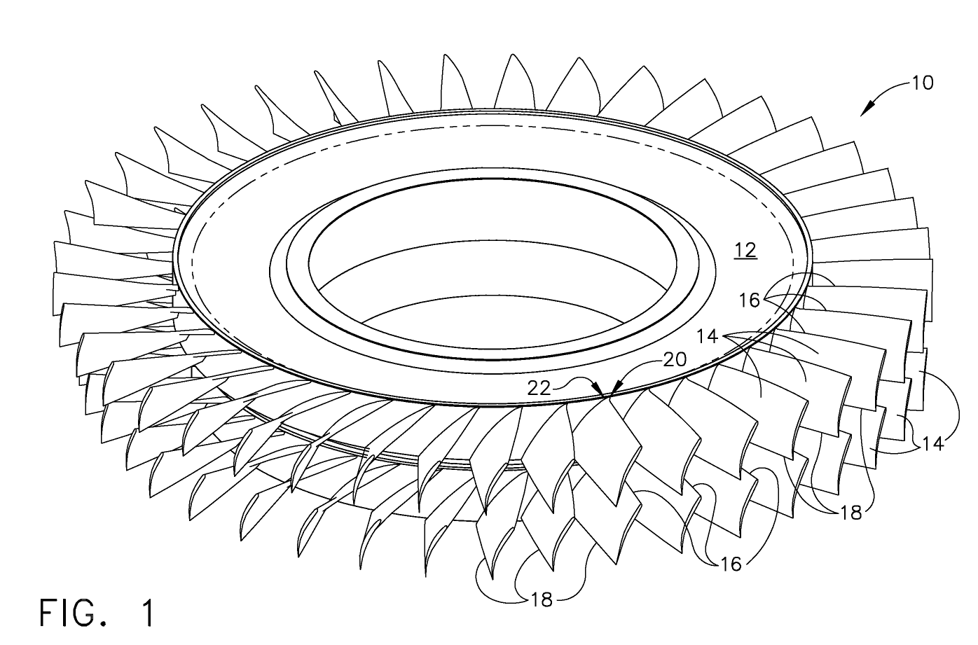

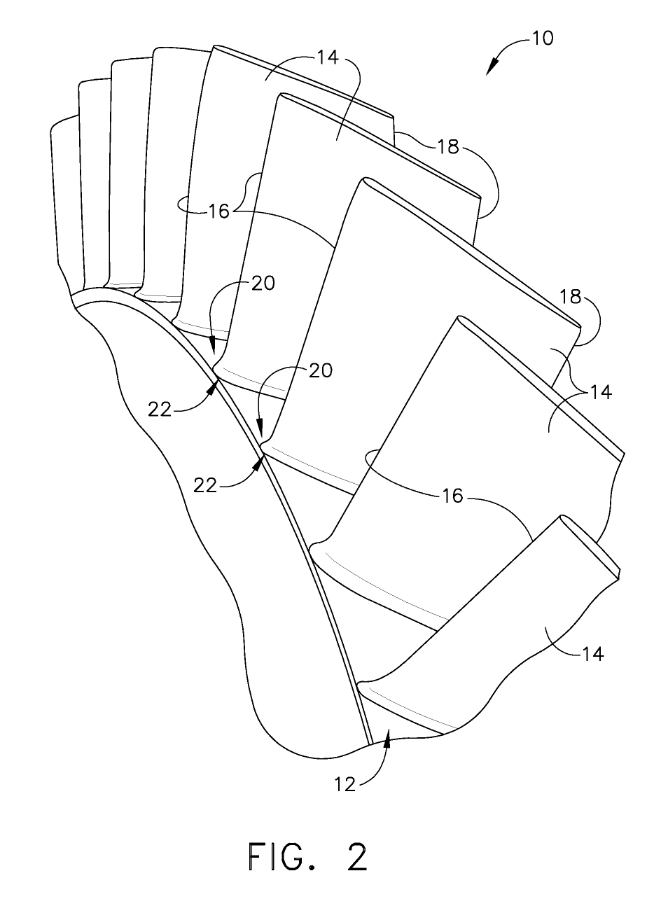

FIGS. 1 and 2 illustrate an exemplary turbine engine component 10. More specifically, FIG. 1 is a perspective view of an exemplary blisk 10 for a gas turbine engine (not shown) and FIG. 2 is a fragmentary perspective view of a portion of blisk 10. Blisk 10 includes a hub 12 and a plurality of airfoils 14 that extend radially outward from hub 12. Each airfoil 14 includes a leading edge 16 and a trailing edge 18. During manufacturing of blisk 10, excess material 20 may be produced at an intersection 22 of each leading edge 16 and hub 12. In addition, and/or alternatively, excess material may also be generated at an intersection between trailing edge 18 and hub 12. In addition, and/or alternatively, excess material may also be generated along leading edge 16 and/or trailing edge 18 and may encircle the entire blade circumference and extend from the blade surface, over the fillet radius and onto the hub 12. In some embodiments, at least some excess material 20 requires removal to “blend” each of leading edge 16 into predetermined dimensions for hub 12 and airfoil 14.

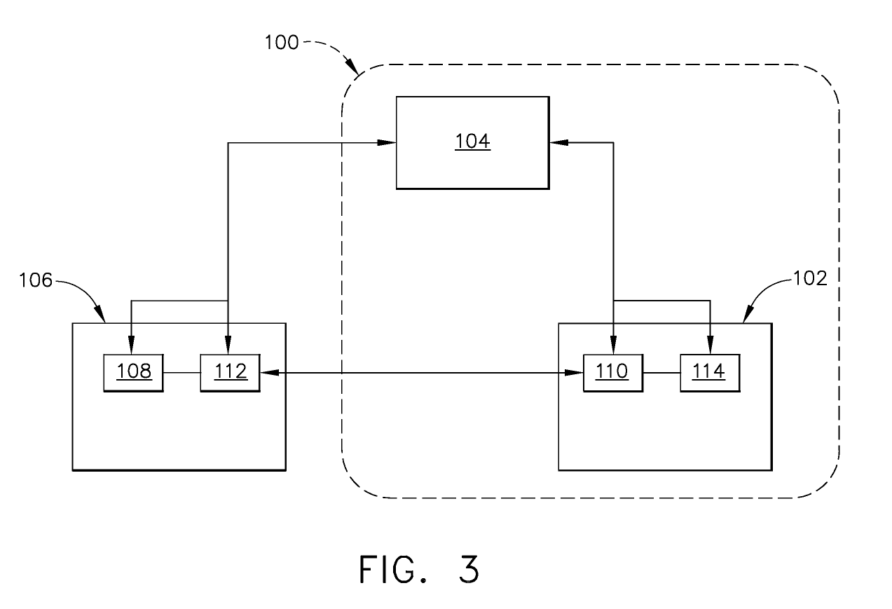

FIG. 3 is a schematic view of an exemplary embodiment of a system 100 for use in fabricating a component such as, but not limited to, blisk 10 (shown in FIG. 1). System 100 generally includes a measuring tool 102 used to measure at least one property of the component, and a processor 104 operatively connected to measuring tool 102 for receiving measurements therefrom. Generally, and as will be described in more detail below, in one embodiment system 100 is operable to determine an actual property of a region (not shown in FIG. 3) of the component, and to compare the actual property with an expected property of the region to determine a difference between the actual property and the expected property. Moreover, system 100 is also operable to update a path of a fabricating tool 106 that is electronically stored in a memory 108 associated with, and operatively connected to, fabricating tool 106 and is also executable to at least partially fabricate the component based on the determined difference between the actual property and the expected property.

In the exemplary embodiment, to assist manufacturing processes that fabricate a finished component, a model of an expected geometry of the component is generated, as described in more detail herein. The model includes the geometry of unfinished surfaces of the component and/or finished surfaces that are fabricated during a manufacturing process. To fabricate one or more finished surfaces, a path of fabricating tool 106 is generated based on the geometry of the model, and more specifically based on the geometry of the expected finished surface(s) on the model. In one embodiment, for example, system 100 updates the path of fabricating tool 106 based on actual properties of the particular component being fabricated, and more specifically based on the difference between the actual properties of the particular component being fabricated and the expected properties of the model. In the exemplary embodiment, processor 104 does not generate the model of expected geometry of the component and/or does not generate the path of fabricating tool 106 based on the geometry of the model, but rather, a processor 110 associated with and operatively connected to measuring tool 102, for controlling operation of measuring tool 102, generates the model of expected geometry of the component. Moreover, in one embodiment, for example, processor 110 generates the path of fabricating tool 106 based on the geometry of the model. Even further, in one embodiment, and for example, a processor 112 associated with, and operatively connected to, fabricating tool 106 controls operation of fabricating tool 106, and generates the path of fabricating tool 106 based on the geometry of the model. However, in an alternative embodiment, processor 104 generates the model of expected geometry of the component and/or the path of fabricating tool 106 based on the geometry of the model.

Although memory 108 is described and illustrated herein as associated with fabricating tool 106, for example as a part of a machine (not shown) including fabricating tool 106, in one embodiment memory 108 is associated with processor 104 and/or measuring tool 102.

Fabricating tool 106 may be any tool used in fabricating the component by changing a property of the component, such as, but not limited to, through removing material from the component to fabricate a finished surface. For example, in one embodiment fabricating tool 106 is a machining tool. Although only one fabricating tool 106 is illustrated, it should be understood that system 100 may include and/or cooperate with any number of fabricating tools 106 to facilitate changing any number and/or type of properties at any component region. The desired fabricating path of fabricating tool 106 is electronically stored in memory 108 and is executable by processor 112. In one embodiment, fabricating tool 106 is coupled to a Computer Numerical Control (CNC) machine and the path of fabricating tool 106 is a computer numerical control path executed by processor 112, which, for example, may control operation of at least a portion of the CNC machine. Processor 104 may be operatively connected to memory 108 for accessing and updating the path of fabricating tool 106 stored therein. For example, in one embodiment processor 104 is operatively connected to memory 108 through processor 112. In another embodiment, processor 104 is directly connected to memory 108. In one embodiment, processor 104 and/or processor 110 is a personal computer. Although only one processor 104 is described and illustrated herein, it should be understood that any number of processors 104 may be used to perform any or all operations of processor 104 and/or system 100 generally that are described and/or illustrated herein. Moreover, in one embodiment, processor 112 and/or processor 110 perform any of the operations of processor 104 described and/or illustrated herein. Similarly, in one embodiment processor 104 performs any of the operations of processors 110 and/or 112 described and/or illustrated herein. One or more processor(s) that perform any of the operations described and/or illustrated herein with respect to processors 104, 110, and/or 112 may be a part of a machine that manufactures the component (e.g., a CNC machine), may be a part of a machine that measures the component (e.g., measuring tool 102 and associated components thereof), and/or may be a processor dedicated to system 100 and operatively connected to the machine(s).

Measuring tool 102 may be any tool for measuring any physical property of the component. Although only one measuring tool 102 is shown in FIG. 3, it should be understood that the system 100 may include any number of measuring tools 102 for measuring any number and/or type of properties at any region(s) of the component. Measuring tool 102 may be located adjacent fabricating tool 106 such that measuring tool 102 can measure the component when the component is mounted adjacent fabricating tool 106 for fabrication thereof. Alternatively, in one embodiment measuring tool 102 is located remote from fabricating tool 106 such that measuring tool 102 measures the component remote from the fabricating tool 102. In one embodiment, measuring tool 102 is a part of an inspection machine, such as, but not limited to, a coordinate measuring machine, commercially available from Sheffield Measurement, Inc. of Fond du Lac, Wis. In one embodiment, measuring tool 102 is part of a machine including fabricating tool 106 (e.g., a Computer Numerical Control (CNC) machine), such as, but not limited to, an on-machine probing system commercially available from Marposs Corp., of Auburn Hills, Mich. The model of expected geometry of the component may be stored in a memory 114 associated with and operatively connected to measuring tool 102. Alternatively, the model of expected geometry of the component may be stored in memory 108. Processor 104 may be operatively connected to processor 110, memory 114, and/or memory 108 for accessing and updating the geometry of the model, and more specifically the geometry of the finished surface(s) on the model.

Further, although the present invention is described with respect to processors and computer programs, as will be appreciated by one of ordinary skill in the art, the present invention may also apply to any system and/or program that is configured to automatically update an existing non-associative machining tool in response to changes in component geometry. For example, as used herein, the term processor is not limited to just those integrated circuits referred to in the art as processors, but broadly refers to computers, processors, microcontrollers, microcomputers, programmable logic controllers, application specific integrated circuits, and other programmable circuits. The processor may be part of a computer that may include a device, such as; a floppy disk drive or compact disc-read-only memory (CD-ROM) drive, for reading data from a computer-readable medium, such as a floppy disk, a CD-ROM, a magneto-optical disk (MOD), or a digital versatile disc (DVD).

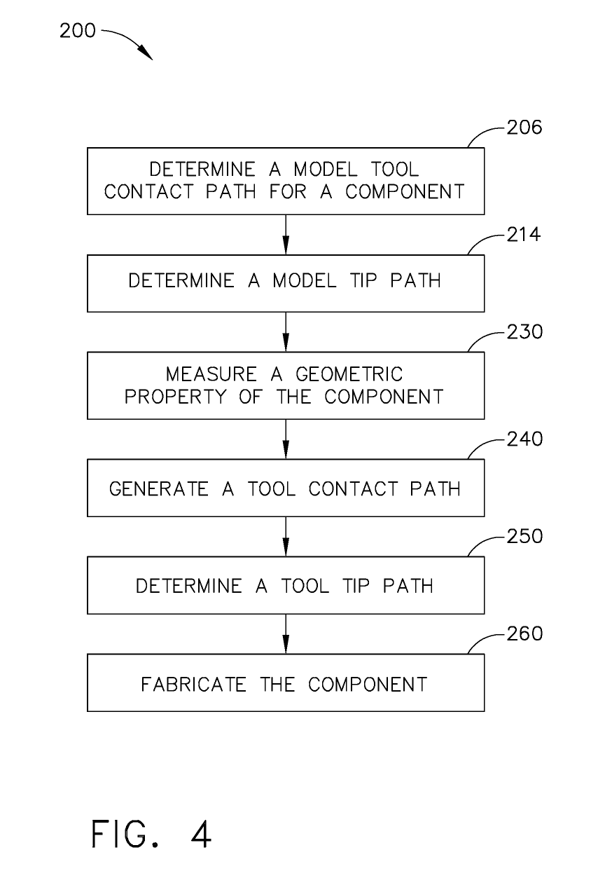

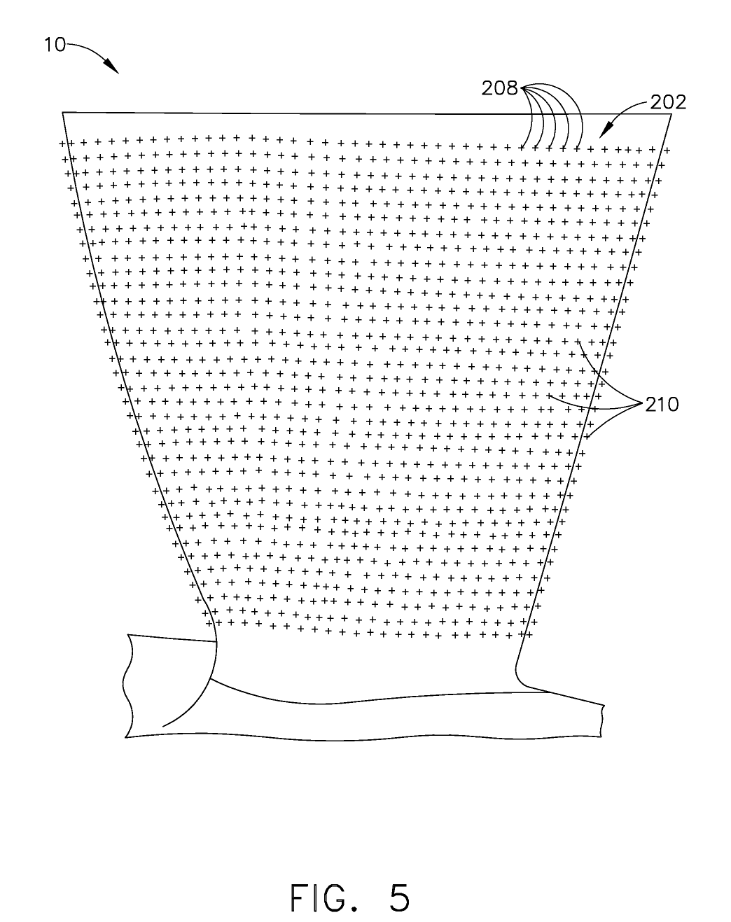

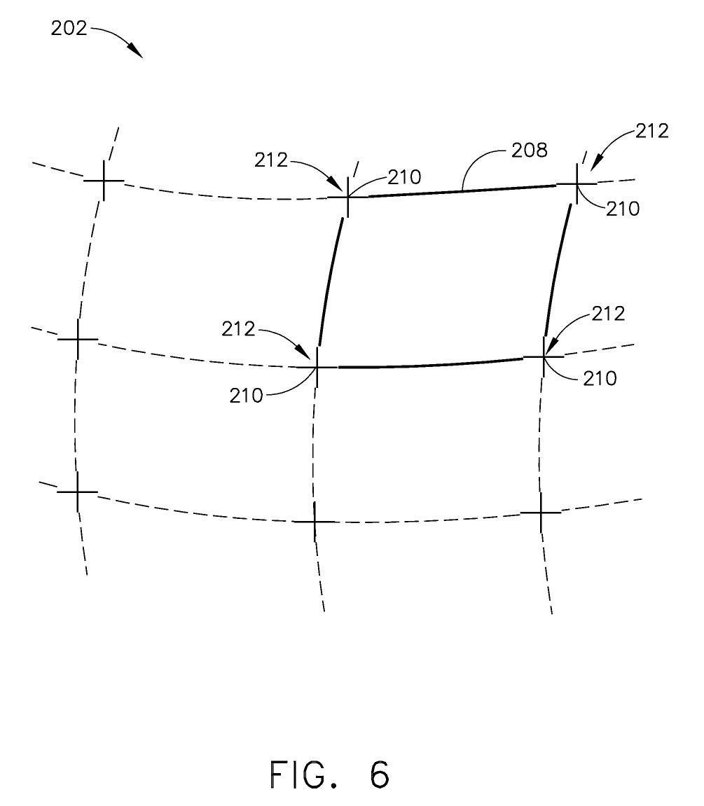

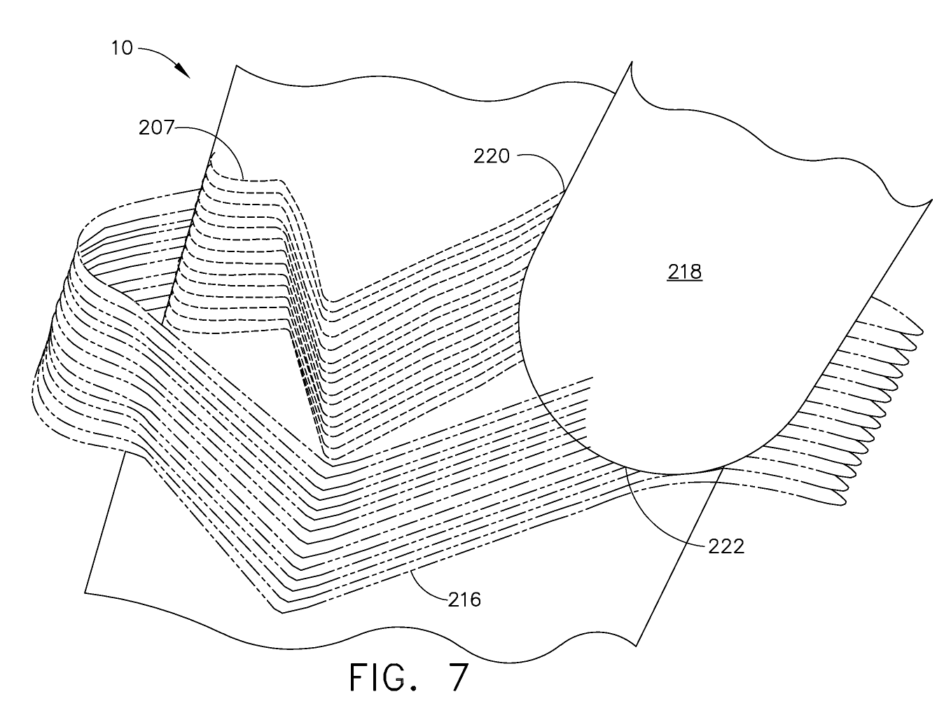

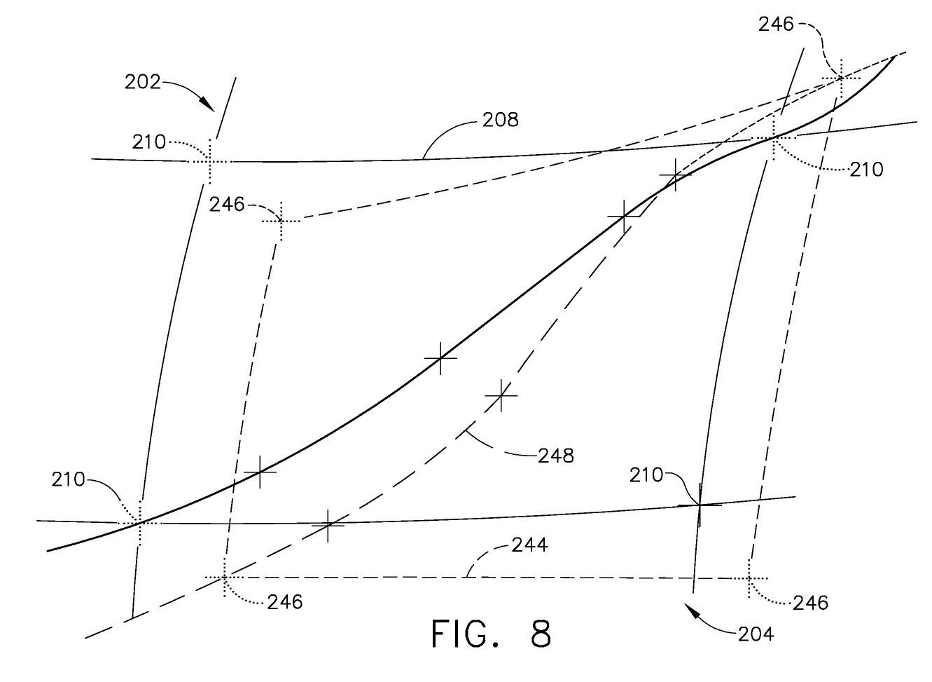

FIG. 4 is a flow chart illustrating an exemplary method 200 for use in fabricating a component, such as, but not limited to blisk 10 (shown in FIGS. 1 and 2). FIG. 5 is a perspective view of blisk 10 with a superimposed grid 202, and FIG. 6 is a schematic illustration of grid 202 shown in FIG. 5. FIG. 7 is a schematic illustration of blisk 10 during fabrication. FIG. 8 is schematic illustration of a portion of a transformed grid 204 shown in FIG. 6. In the exemplary embodiment, method 200 is performed using system 100 (shown in FIG. 3) and fabricating tool 106 (shown in FIG. 3), including any associated components thereof. Although the expected geometry model of blisk 10 may have any number of dimensions, in one embodiment the model of expected geometry of blisk 10 includes three dimensions. Although the model of expected geometry of blisk 10 may be created using any suitable method, software, and/or system, in one embodiment the model is created at least partially using UNIGRAPHICS® CAD/CAM software. (UNIGRAPHICS® is a trademark of UGS PLM Solutions, Inc. of Plano, Tex., and UNIGRAPHICS® CAD/CAM software is available from UGS PLM Solutions Inc., Maryland Heights, Mo.)

In the exemplary embodiment, method 200 includes determining 206 a model tool contact path 207 for blisk 10 (shown in FIGS. 1 and 2), based on blisk geometry, given nominal tool tip path and tool geometry. More specifically, system 100 (shown in FIG. 3) creates grid 202 based on an expected geometry of at least a portion of blisk 10 (shown in FIG. 5). In the exemplary embodiment, grid 202 includes a plurality of elements 208 and nodes 210 defined at an intersection 212 of elements 208, as shown in FIG. 6. The plurality of elements 208 and nodes 210 define model tool contact path 207. Model tool contact path 207 is then generated based on the expected component geometry and tool geometry, as shown in FIG. 7. In the exemplary embodiment, the expected component geometry includes at least one of an expected shape of blisk 10, an expected size of blisk 10, and an expected orientation of blisk 10. Alternatively, the expected geometric property may be any property that enables system 100 to function as described herein.

In the exemplary embodiment, method 200 includes determining 214 a model tip path 216 using the determined 206 model tool contact path 207 that is offset from the model tool contact path 207. A fabricating tool 218, similar to fabricating tool 106 described herein, includes a contact point 220 that contacts blisk 10 during manufacturing operations. In the exemplary embodiment, contact point 220 is offset from a tool tip 222, as shown in FIG. 7. Alternatively, tool contact point 220 may be substantially aligned with tool tip 222.

Method 200 includes measuring 230 a geometric property of the component relative to the model component geometry using measurement tool 102 described herein. In the exemplary embodiment, the measured 230 geometric property includes at least one of an actual shape of blisk 10, an actual size of blisk 10, and an actual orientation of blisk 10. Alternatively, the measured 230 geometric property may be any property that enables system 100 to function as described herein.

Method 200 includes generating 240 a tool contact path corresponding to the measured 230 geometric property. In the exemplary embodiment, the generated 240 tool path is transformed based on a difference between the measured 230 geometry of the component and the determined 214 model tool contact path 207. More specifically, transforming the generated 240 tool contact path further includes interpolating a displacement of the determined plurality of elements 208 and nodes 210 using the generated 240 tool contact path, resulting in an transformed grid 204 defining a plurality updated elements 244, updated nodes 246, and an updated contact path 248, as shown in FIG. 8. An updated tip path (not shown) that is offset from the tool contact path is then determined 250 using the generated tool contact path 240, the offset being related to the geometry of the tool 218, as described in more detail herein.

In the exemplary embodiment, method 200 includes fabricating 260 the component using the determined 250 updated tip path. More specifically, fabricating 260 the component includes guiding the tool 218 using the determined tip path 250 to machine blisk 10.

As will be appreciated based on the foregoing specification, the above-described embodiments of the disclosure may be implemented using computer programming or engineering techniques including computer software, firmware, hardware or any combination or subset thereof, wherein the technical effect is to automatically update an existing non-associative machining tool in response to changes in component geometry. Any such resulting program, having computer-readable code means, may be embodied or provided within one or more computer-readable media, thereby making a computer program product, i.e., an article of manufacture, according to the discussed embodiments of the disclosure. The computer readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a method and system of automatically update an existing non-associative machining tool in response to changes in component geometry. More specifically, the methods and systems described herein facilitate quickly and efficiently updating on-machine inspection data using geometry morphing algorithms without the need for integrated CAD/CAM systems. Accordingly, the methods and systems described and/or illustrated herein may facilitate decreasing a cost of producing a batch of components and/or increasing production of a batch components. For example, the methods and systems described and/or illustrated herein may facilitate the automation of a blending process, thereby possibly reducing manual blending processes while increasing repeatability and reliability of the system, and while reducing fabrication costs and time cycles. Therefore, it is desirable to provide an automated system and method for planning a tool path along a surface of a workpiece in surface-based manufacturing applications. As a result, the set-up time and cost to make a new part can be significantly reduced and thereby improve the quality of the manufacturing process.

Although the methods and systems described and/or illustrated herein are described and/or illustrated with respect to a gas turbine engine component, and more specifically a blisk for a gas turbine engine, practice of the methods and systems described and/or illustrated herein is not limited to blisks nor gas turbine engine components generally. Rather, the methods and systems described and/or illustrated herein are applicable to fabricating any component.

When introducing elements of the methods and systems described and/or illustrated herein, including any and all embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for fabricating a component using a tool including a tip, said method comprising:
determining a model of a tool contact path for the component based on a model component geometry, the model component geometry including a plurality of elements and nodes at an intersection of the elements;
measuring a geometric property of the component relative to the model component geometry;
generating a tool contact path corresponding to the measured geometric property; and
at least partially fabricating the component using the generated tool contact path.

2. A method in accordance with claim 1, further comprising determining a model tip path using the determined model of the tool contact path that is offset from the tool contact path, the offset related to the geometry of the tool.

3. A method in accordance with claim 1, further comprising determining a tip path using the generated tool contact path that is offset from the tool contact path, the offset related to the geometry of the tool.

4. A method in accordance with claim 1, wherein generating a tool contact path further comprises updating the generated tool path based on a difference between the measured geometry of the component and the determined model tool contact path.

5. A method in accordance with claim 4, wherein updating the generated tool path further comprises interpolating a displacement of the determined plurality of nodes and elements using the generated tool contact path.

6. A method in accordance with claim 1, wherein determining a tool contact path further comprises:
creating a model of an expected geometry of at least a portion of the component; and
generating a tool contact path based on the created model.

7. A method in accordance with claim 1, wherein at least partially fabricating the component further comprises guiding the tool using the generated tip path to machine the component.

8. A method in accordance with claim 1, wherein the measured geometric property comprises at least one of an actual shape, an actual size, and an actual orientation, wherein the component geometry comprises at least one of an expected shape, an expected size, and an expected orientation.

9. A system for fabricating a component using a fabricating tool, said system comprising:
at least one machining tool configured to machine at least a portion of the component; and
a processor operatively coupled to said machining tool and configured to execute a process that facilitates fabricating the component, said processor is programmed to:
determine a model of a tool contact path for the component based on a model component geometry, the component geometry including a plurality of elements and nodes at an intersection of the elements;
measure a geometric property of the component relative to the model component geometry; and
generate a tool contact path corresponding to the measured geometric property.

10. A system in accordance with claim 9, wherein said processor is further programmed to determine a model tip path using the determined model tool contact path, wherein the model tool contact path is offset from the tool contact path, the offset related to the geometry of the tool.

11. A system in accordance with claim 9, wherein said processor is further programmed to determine a tip path using the generated tool contact path, wherein the tip path is offset from the tool contact path, the offset related to the geometry of the tool.

12. A system in accordance with claim 9, wherein generating a tool contact path further comprises updating the generated tool path based on a difference between the measured geometry of the component and the determined model tool contact path.

13. A system in accordance with claim 12, wherein updating the generated tool path further comprises interpolating a displacement of the determined plurality of nodes and elements using the generated tool contact path.

14. A system in accordance with claim 9, wherein the processor is further programmed to:
create a model of an expected geometry of at least a portion of the component; and
generate a tool contact path based on the created model.

15. A system in accordance with claim 9, wherein the model tool contact path is a computer numerical control path.

16. A system in accordance with claim 9, wherein said processor is further programmed to determine a tip path using the generated tool contact path, wherein the tip path is substantially aligned with the tool contact path.

17. A method for fabricating a component comprising:
mapping an expected surface of the component using a plurality of elements and nodes at an intersection of the elements;
generating a plurality of tool contact paths based on said mapped expected surface;
determining a plurality of tool tip paths using the generated plurality of tool contact paths, wherein the plurality of tool tip paths are offset from the plurality of tool contact paths, the offset related to the geometry of the tool;
measuring an actual portion of the surface of the component relative to the mapped expected surface;
transforming said plurality of elements and nodes using said measured actual surface; and
interpolating a correlated displacement of an actual tool tip path using said transformed plurality of elements and nodes.

18. A method in accordance with claim 17, further comprising at least partially fabricating the component using said interpolated tool tip path.

19. A method in accordance with claim 18, wherein at least partially fabricating the component further comprises guiding the tool using the generated tip path to machine the component.

20. A method in accordance with claim 17, wherein interpolating a correlated displacement further comprising updating a position of the actual tool tip path based on said transformed plurality of elements and nodes.
